(19) United States
(12) Patent Application Publication
(10) Pub. No.: US 2024/0349736 A1
(43) Pub. Date: Oct. 24, 2024

(54) Conveyor Tunnel Oven

(71) Applicant: Wolfe Electric, Inc., Wichita, KS (US)

(72) Inventors: Chad Jones, Wichita, KS (US); Justin Strodtman, Wichita, KS (US)

(73) Assignee: Wolfe Electric, Inc., Wichita, KS (US)

(21) Appl. No.: 18/763,308

(22) Filed: Jul. 3, 2024

Related U.S. Application Data
(60) Provisional application No. 63/642,164, filed on May 3, 2024.

(51) Int. Cl. A21B 1/46; A21B 1/50

(52) U.S. Cl. CPC A21B 1/46; A21B 1/50

(57) ABSTRACT

A conveyor tunnel oven incorporating a main baking chamber having a longitudinal end wall and an oppositely longitudinal end wall; and food item intake and output ports respectively opening the main baking chamber at the longitudinal and oppositely longitudinal end walls; the conveyor tunnel oven further incorporating a food conveyor extending through the ports and the main baking chamber; conveyor tunnel oven further incorporating an auxiliary baking chamber and mounting plate combination attached to the main baking chamber, the mounting plate positioning the auxiliary baking chamber over a conveyor end selected from the group consisting of the food conveyor's longitudinal end and the food conveyor's oppositely longitudinal end.

### REFERENCE TO PREVIOUSLY FILED PATENT APPLICATION

This non-provisional patent application claims the benefit of and priority from U.S. Provisional Patent Application No. 63/642,164 filed May 3, 2024. The inventors and applicant disclosed in said provisional application are the same persons as the persons who are disclosed as the inventors and applicant of the instant application.

### FIELD OF THE INVENTION

The instant invention relates to tunnel ovens of the type which include a baking case or baking chamber which is opened by and food item input and output ports. A continuous loop grate type food conveyor commonly extends through the oven's baking chamber, such conveyor's ends extending outwardly from said ports. Such tunnel ovens also commonly include cooking air impingement registers which overlie and/or underlie the central portion of the conveyor which extends through the oven's baking chamber. More particularly, the instant invention is related to adaptations of such conveyor tunnel ovens for varying the effective cooking or baking times applied by the oven to food items carried by the conveyer.

### BACKGROUND OF THE INVENTION

Conveyor adapted food baking tunnel ovens are known to include interior forced air registers which are adapted to direct jets of heated cooking air toward food items conveyed through the oven. The cooking times of such known and conventional conveyor tunnel ovens are typically altered or adjusted only by means of altering the conveyor's cycling speed.

In many instances, altering such oven's conveyor speed to accommodate a food item type will temporarily interfere with use of oven for cooking other types of food. For example, such oven's conveyor speed may be slowed to increase the cooking time applied by the oven to a relatively dense and slowly heated food item such as chicken wings. While such oven operates with a reduced chicken wings accommodating conveyor speed, the oven may not be used for baking a less dense and more quickly heated food item, such as a thin crust pizza. The increased cooking time applied by the oven to the chicken wings may, for example, undesirably burn a thin crust pizza which is mistakenly introduced into the oven between chicken wing insertions.

To properly bake the thin crust pizza, the conveyor speed may be increased, temporarily precluding use of the oven for cooking denser items such as chicken wings. Accordingly, in use of such conventional conveyor tunnel ovens, the time periods dedicated to utilization of the oven for cooking chicken wings give rise to a threat of mistakenly overcooked pizzas. In any event, the oven usage periods dedicated to cooking chicken wings may result in an undesirable delay in use of the oven for cooking thin crust pizzas. Conversely, resetting the oven's conveyor speed to accommodate faster pizza cooking times may result in delays in use of the oven for baking more dense food items such as chicken wings, or may result in mistakenly undercooked chicken wings.

The instant inventive conveyor tunnel oven solves of ameliorates the problems, defects, and deficiencies of conventional conveyor tunnel ovens, as described above, by incorporating into the oven at its food input and/or food output port specialized auxiliary baking chambers.

### BRIEF SUMMARY OF THE INVENTION

A first structural component of the instant inventive conveyor tunnel oven comprises a baking chamber or case having a longitudinal end wall and an oppositely longitudinal end wall, the baking chamber also having an upper ceiling or wall and a lower floor or wall. The baking chamber also has a rear wall and a front wall which is often configured as a removable access panel.

The instant inventive conveyor tunnel oven preferably further comprises rectangular and laterally oblongated food intake and food output ports which respectively opening the baking chamber at the longitudinal and oppositely longitudinal end walls.

A further structural component of the instant inventive conveyer tunnel oven comprises a continuous loop grate type food conveyor which extends longitudinally through the baking chamber's interior space. Such conveyor preferably has a longitudinal end which extends longitudinally from the food intake port, and has an oppositely longitudinal end which extends oppositely longitudinally from the food output port. In the preferred embodiment, the food conveyor has a lateral span or width which extends leftwardly and rightwardly commensurately with the lateral dimension of the food intake and food output ports.

A further structural component of the instant inventive conveyor tunnel oven comprises a first, and preferably first and second auxiliary baking chambers. In the preferred embodiment, each auxiliary baking chamber is configured as a downwardly opening “C” channel having open longitudinal and oppositely longitudinal ends. To form such channels, each auxiliary chamber preferably comprises an upper ceiling or wall, and lateral and oppositely lateral, i.e. rear and front walls. In a preferred embodiment, the lateral widths of the auxiliary baking chambers are great enough to allow longitudinal passages therethrough of food items to be baked such as chicken wings within a baking pan. In such embodiment, the lateral width of the auxiliary baking chambers is less than the width of the conveyor to allow a lateral or oppositely lateral side of the conveyor to be simultaneously utilized for carriage of more quickly cooked food items such as pizzas. Accordingly, in the preferred embodiment, the lateral widths of the conveyor and the food passage ports exceed the lateral width of the auxiliary baking chambers by a distance at least as great as the diameter of a large pizza, such width differential allowing relatively quickly cooked pizzas and relatively slowly cooked pans of chicken wings to be substantially cooked withing the oven at a single conveyor speed setting.

The instant inventive conveyor tunnel oven preferably further comprises first mounting means which are adapted for securely mounting the auxiliary baking chambers upon the longitudinal and oppositely longitudinal end walls of the baking chamber. In the preferred embodiment, such mounting means position the auxiliary baking chambers so that their interior spaces communicate with the food intake and food output ports. In such embodiment, the mounting means cantilever the auxiliary baking chambers longitudinally and oppositely longitudinally from the end walls of the baking chamber, such cantilevering extensions allowing the auxiliary baking chambers to overlie upper surfaces of the outward extensions of the oven's food conveyor without contacting the conveyor.

In a preferred embodiment, the auxiliary baking chamber mounting means comprise plates which are rigidly attached to the ends of such chambers which communicate with the food passage ports. Upon provision of such mounting means, screw fasteners, nut-and-bolt fasteners, or threaded lug and nut fasteners, may be provided for securely attaching the mounting plates and their rigidly supported auxiliary baking chambers to the end walls of the baking chamber. Other commonly known means and mechanisms for attaching the auxiliary baking chambers to the end walls of the oven's main baking chamber, such as directly bolted attachments and slide bracket attachments, are considered to fall within the scope of the invention.

In use of the instant inventive conveyor tunnel oven, an operator of the oven may set the conveyor's cycling speed to match the cooking time needed to properly cook pizzas. Thereafter, the operator may place an uncooked pizza upon the upper surface of the longitudinal extension of the food conveyor, such placement situating the uncooked pizza immediately longitudinally from the oven's food intake port. Such placement preferably further situates the pizza oppositely laterally from and outside of the auxiliary baking chamber. Thereafter, the conveyor tunnel oven may proceed to convey and bake the pizza, applying a proper length of baking time to the pizza.

In the event the operator seeks to utilize the oven for baking a pan of chicken wings, the operator may alternatively place the chicken wing pan at the longitudinal opening at the input end auxiliary baking chamber. During the conveyor's carriage of the chicken wing pan through the auxiliary baking chamber, cooking and baking of the chicken wings commences prior to entry of the pan into the oven's larger baking chamber. The effective baking time applied by the inventive oven to the chicken wings is advantageously lengthened without altering the conveyor's cycling speed.

Accordingly, objects of the instant invention include the provision of a conveyor tunnel oven which incorporates structures as described above, and which arranges those structures in relation to each other in manners described above for the performance of beneficial functions described above. Other and further objects, benefits, and advantages of the instant invention will become known to those skilled in the art upon review of the detailed description which follows, and upon review of the appended drawings.

### BRIEF DESCRIPTION OF THE DRAWINGS

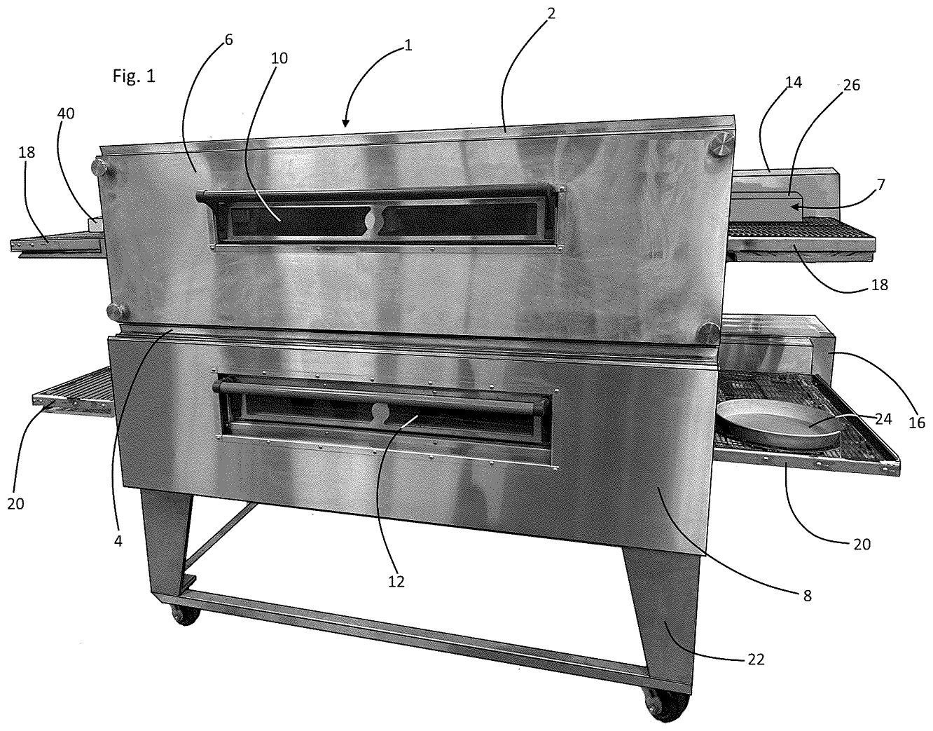

Drawing FIG. 1 is a front view of a stacked pair of air impingement adapted conveyor tunnel ovens, the upper oven including auxiliary baking chambers.

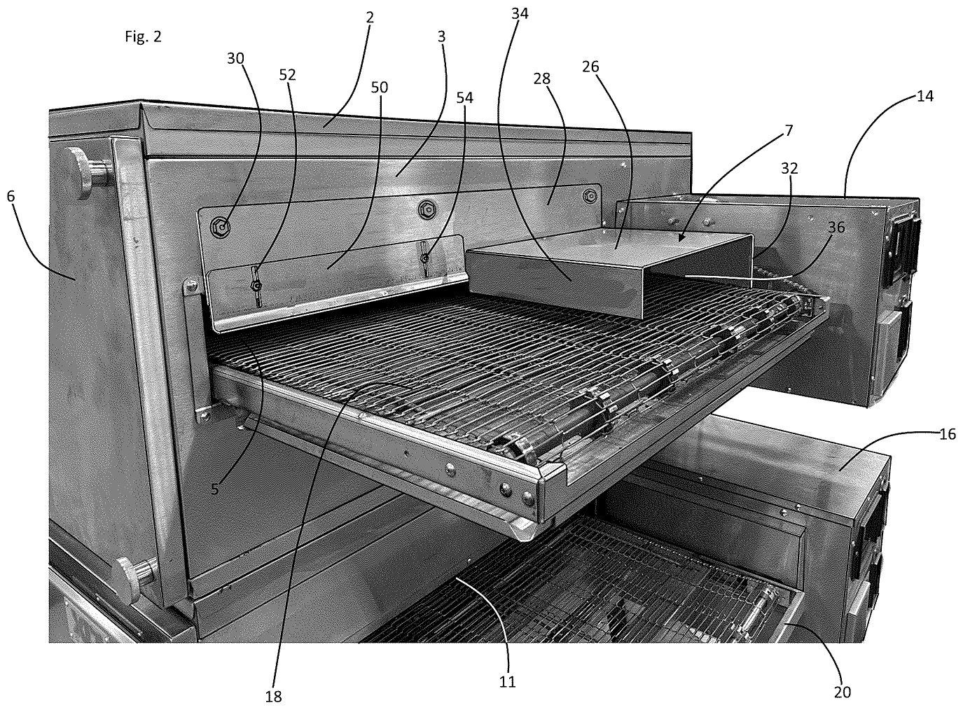

Drawing FIG. 2 is partial perspective view of the longitudinal ends of FIG. 1 ovens.

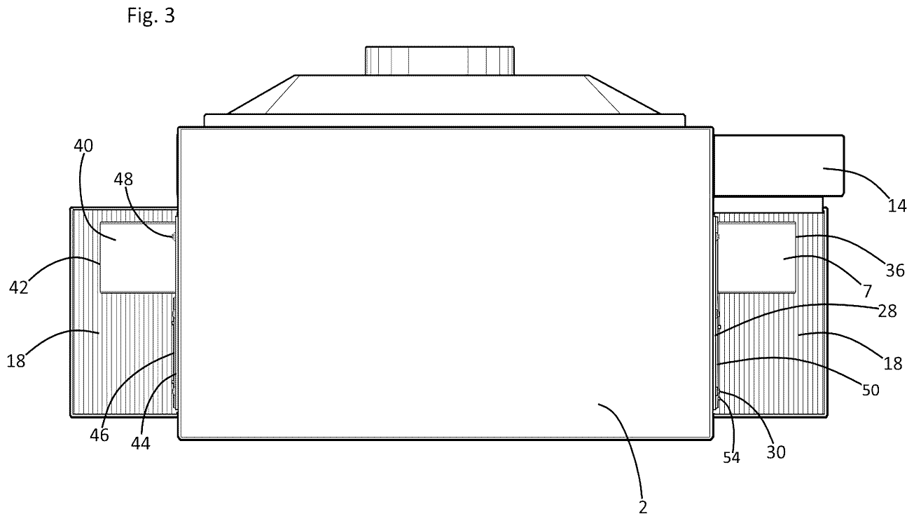

Drawing FIG. 3 is an upper plan view of the oven of FIGS. 1 and 2.

### DETAILED DESCRIPTION

Referring to FIG. 1, a stacked pair of conveyor tunnel ovens is referred to generally by reference arrow 1. The oven stack 1 includes an upper conveyor tunnel oven 2, and a lower conveyor tunnel oven 4, such ovens commonly including attachable and removable front, oppositely lateral wall panels 6 and 8 which incorporate pivoting side access doors 10 and 12.

Longitudinal and oppositely longitudinal ends of the ovens, respectively appearing rightwardly and leftwardly in the view of FIG. 1, present food item input ports and food item output ports. The ovens' longitudinal opening food item intake ports 5 and 11 are shown in the view of FIG. 2. Mirroring oppositely longitudinal food item output ports open the ovens' baking chambers at their oppositely longitudinal end walls, such oppositely longitudinal food output ports not being shown within the views of FIGS. 1-3.

Continuous loop grate type food conveyors 18 and 20 extend longitudinally through the interior spaces or main chambers of the tunnel ovens 2 and 4. Such conveyors 18 and 20 have longitudinal and oppositely longitudinal ends which respectively extend or protrude longitudinally and oppositely longitudinally from the ovens' food item intake and output ports. Control cases 14 and 16 house the ovens' electronic controllers, motor means for driving the conveyors 18 and 20, and gas or electric heating components.

Referring simultaneously to FIGS. 1-3, the upper conveyor tunnel oven 2 has a longitudinal end wall 3, such wall being opened by the rectangular and laterally oblongated food item intake port 5, the longitudinal end of the food conveyor 18 extending longitudinally from such port. At least a first auxiliary baking chamber 7, preferably composed of sheet stainless steel, is formed and defined by an upper wall or ceiling 26, a rear or lateral wall 32, and a front or oppositely lateral wall 34. Such walls advantageously form a downwardly opening and longitudinally extending “C” channel. The oppositely longitudinal end of the auxiliary baking chamber 7 is open, such end communicating with the food intake port 5. The open longitudinal end 36 of chamber 7 is similarly open for inputs of food items to be carried by the conveyor 18.

One or more of the oppositely longitudinal ends of chamber walls 26, 32, or 34 are rigidly connected to and are supported by a vertical mounting plate 28 which is suitably fastened to the oven's end wall 3 by nut and bolt fasteners 30. Such mounting plate 28 supports and holds the auxiliary baking chamber 7 in a longitudinal and cantilevering extension which positions the chamber 7 directly above the longitudinal end of the conveyor 18. Such mounting plate 3 is considered to constitute a mounting means component of the invention, and other commonly known types of mechanical fasteners capable of fixedly and removably mounting the auxiliary baking chamber 7 upon end wall 3 are considered to fall withing the scope of the invention. For example, slide bracket fasteners may be suitably substituted as the inventions mounting means. Alternatively, screw fasteners may be utilized to secure the auxiliary baking chamber upon the end wall 3.

A substantially mirroring second auxiliary baking chamber 40 having an oppositely longitudinal food item output opening 42 is preferably fixedly attached to the oppositely longitudinal end wall of the oven 2. Such second and mirroring auxiliary baking chamber 40 preferably similarly includes a “C” channel forming upper wall, rear wall, and front wall combination. Second mounting means, preferably comprising a second mounting plate 44, is configured substantially identically with the first mounting means components 28 and 32, such second mounting means being fastened upon the oven's oppositely longitudinal end wall by nut and bolt fasteners 48.

In use and operation of the instant inventive conveyor tunnel oven 1, and assuming that the oven includes the preferred first and second mirroringly mounted auxiliary baking chambers 7 and 40, dense and relatively slowly cooked food items such as chicken wings may be initially placed upon and contained within a baking pan or tray 24. The peripheral wall of such baking pan or tray 24 preferably has a vertical height dimension which is less than the vertical distance or elevation between the upper flight of the conveyor 18 and the upper wall 26 of the first auxiliary baking chamber 7. Such relative sizing of the interior height of the auxiliary baking chamber with respect to the baking pan's height allows the pan and its contents to be carried by the conveyor oppositely longitudinally into and through the longitudinal opening 36, and then through the interior of the auxiliary chamber. To initiate such food item passage through the auxiliary chamber 7, the operator may simply place the food containing pan 24 upon the conveyor 18 at a location immediately longitudinally from the chamber opening 36.

The open communication between the oppositely longitudinal end of auxiliary baking chamber 7 and oven's food intake port 5 allows radiant heat and heated air within the interior of baking case 2 emanate into and heat the interior of chamber 7. Such chamber heating advantageously causes baking of food items placed upon the conveyor 18 at the longitudinal opening 36 of the auxiliary chamber to commence prior the food item's passage through input port 5. Cooking time applied to such food item is therefore advantageously increased by means of the operator's selective placement of the pan at the chamber's entry port 36. Correspondingly, cooking time applied to more quickly cooked food items, such as thin crust pizzas, may be selectively decreased by the operator by placing the pizza upon the conveyor 18 oppositely laterally from and outside of the auxiliary baking chamber 7.

A downwardly extending flange component 50 of the mounting flange 28 preferably has a lower lip or edge which resides at an elevation below the elevation of auxiliary chamber's upper wall 26. In the preferred embodiment, the elevation of such flange's lower edge above the conveyor 18 is less than the height of the upper wall of the auxiliary baking chamber 7. Such differential in elevations of the flange's lower edge and the auxiliary chamber's upper wall advantageously assures that, upon an erroneous placement of the pan 24 upon the conveyor 18 oppositely laterally from the auxiliary baking chamber 7, such pan and food items contained therein will be blocked from entry into the interior of the baking case 2. Accordingly, the flange 50 functions as a pan entry blocking member which may advantageously prevent undercooked food items from exiting the opposite end of the oven. The operator, upon seeing that the pan has been blocked by flange 50 from entry into the oven, may retrieve the pan, and my correctly place the pan longitudinally from the opening 36 of the auxiliary baking chamber 7. The blocking flange 50 may suitably comprise an integral or wholly formed downward extension of the oppositely lateral end of the mounting plate 28. However, as depicted in FIG. 2, such flange may comprise the lower end of an alternatively downwardly extendable and upwardly retractable plate. Travel slots 52 and screw and nut fasteners may be provided to facilitate selective vertical positioning of the lower edge of the blocking flange. In use, an operator may utilize the fasteners 54 and travel slots 52 to adjust the height of such lower edge to reside above the vertical dimension of pizzas carried by the conveyor 18 and to reside below the vertical height of pans which are properly routed through the auxiliary cooking chambers 7 and 40.

The blocking flange 50 in combination with the relatively higher or taller chamber 7 provides a useful mechanical protection or guard against erroneous placements of such chicken wing bearing cooking pans 24. The instant oven's incorporation of flange 50 advantageously avoids any erroneously short baking time applied to chicken wings by blocking such erroneously short oven passage. Accordingly, such flange 50 protects against erroneous undercooking of chicken wings while allowing the oven and conveyor to be safely continuously utilized for baking less dense items such as thin crust pizzas.

In a preferred embodiment of the instant inventive oven, the second auxiliary baking chamber 40 oppositely longitudinally aligns with the first auxiliary baking chamber 7. Provision of such mirroringly installed auxiliary baking chambers advantageously provides needed additional heating and food cooking time at the output end of the conveyor 18.

The instant inventive oven advantageously allows relatively quickly heated and cooked food items, such as thin crust pizzas, to pass through the oven outside of chambers 7 and 40. To initiate such relatively short baking time, an operator may place an uncooked pizza upon the conveyor 18 for passage beneath the pan blocking flange 50 rather than passing through chamber 7. Food items which are less quickly heated and cooked, such as chicken wings, may experience the same conveyor transit time during carriage by conveyor 18, with an additional effective baking time during such transit provided by the longitudinal and oppositely longitudinal auxiliary baking chambers 7 and 40. The instant invention advantageously allows an operator to implement increases and decreases of baking times through the simple expedient of selective left versus right placements of food items on the conveyor 18. Fast cooking and slow cooking food items are simultaneously properly cooked by the inventive oven without any alteration of belt cycling speed.

Fasteners 30 and 48 shown in FIGS. 2 and 3 preferably symmetrically align with and mirror each other so that, upon a deinstallation of chamber 7 and mounting plate 28 from the longitudinal end of the oven, such chamber and plate may be reinstalled upon the oven's oppositely longitudinal end. The preferred symmetry of fasteners similarly allows the second mounting plate 44 and second auxiliary baking chamber 40 to be removed and reinstalled upon the longitudinal end of the oven. Such fastener symmetry facilitated interchange of the first and second auxiliary baking chambers advantageously allows the operator to selectively assign lengthened or shortened effective cooking times to either of the lateral and oppositely lateral sides of the conveyor 18. While the food item passage blocking flange 46 of the second mounting plate 44 is not functionally required while such plate in mounted at the output end of the oven, such flange is needed upon such end-to-end interchange of the auxiliary baking chambers. Accordingly, it is preferred that the auxiliary baking chamber and mounting plate combinations, 7,28 and 40,44, mirroringly identically include blocking flanges 50 and 46.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A conveyor tunnel oven comprising:
a. a baking chamber having a longitudinal end wall and an oppositely longitudinal end wall;
b. a food item intake port and a food item output port, said ports respectively opening the baking chamber at the longitudinal and oppositely longitudinal end walls;
c. a food conveyor having a width, the food conveyor extending through the baking chamber, said conveyor having a longitudinal end extending longitudinally from the food item intake port, and said conveyor having an oppositely longitudinally end extending oppositely longitudinally from the food item output port;
d. a first auxiliary baking chamber having a width less than the food conveyor's width; and
e. first mounting means attaching the first auxiliary baking chamber to the baking chamber, the first mounting means positioning the first auxiliary baking chamber over a conveyor end selected from the group consisting of the food conveyor's longitudinal end and the food conveyor's oppositely longitudinal end.

2. The conveyor tunnel oven of claim 1, further comprising a second auxiliary baking chamber and second mounting means attaching the second auxiliary baking chamber to the baking chamber, the second mounting means positioning the second auxiliary baking chamber over the other conveyer end among said group consisting of the food conveyor's longitudinal end and the food conveyor's oppositely longitudinal end.

3. The conveyor tunnel oven of claim 2, wherein the first auxiliary baking chamber cantilevers from the baking chamber's longitudinal end wall, and wherein the second auxiliary baking chamber oppositely cantilevers from the baking chamber's oppositely longitudinal end wall.

4. The conveyor tunnel oven of claim 3, wherein each auxiliary baking chamber comprises a downwardly opening “C” channel.

5. The conveyor tunnel oven of claim 4, wherein the first auxiliary baking chamber has an interior which communicates with the food intake port, and wherein the second auxiliary baking chamber has an interior which communicates with the food output port.

6. The conveyor tunnel oven of claim 5, wherein each mounting means comprises a mounting plate, wherein said each mounting mean's mounting plate is rigidly attached to one of the auxiliary baking chambers, and wherein said each mounting mean's mounting plate is removably attached to one of the baking chamber's end walls.

7. The conveyor tunnel oven of claim 6, further comprising a food item blocking flange fixedly attached to and extending downwardly from the first mounting means' mounting plate.

8. The conveyor tunnel oven of claim 7, wherein the food item blocking flange has a lower edge, wherein the first auxiliary baking chamber comprises an upper wall, wherein said lower edge and said upper wall are upwardly displaced from the food conveyor, and wherein said lower edge's upward displacement is less than the upward displacement of said upper wall.

9. A baking time adjusting adaptor for attachment to a conveyor tunnel oven, said oven having a plurality of food passage ports, said adaptor comprising:
a. A first mounting plate adapted for removable attachment above one of the food passage ports; and
b. A first auxiliary baking chamber fixedly attached to and cantilevering from the first mounting plate.

10. The adaptor of claim 9, further comprising a first food item blocking flange fixedly attached to and extending downwardly from the first mounting plate.

11. The adaptor of claim 10, wherein the first auxiliary baking chamber has a first upper wall, and wherein the first food item blocking flange has a lower edge residing at an elevation below that of the first upper wall.

12. The adaptor of claim 11, comprising a second mounting plate adapted for removable attachment above another one of the food passage ports, and further comprising a second auxiliary baking chamber fixedly attached to and cantilevering from the second mounting plate.

13. The adaptor of claim 12, further comprising a second food item blocking flange fixedly attached to and extending downwardly from the second mounting plate.

14. The adaptor of claim 13, wherein the second auxiliary baking chamber has a second upper wall residing at an elevation, and wherein the second food item blocking flange has a lower edge residing at an elevation lower than the elevation of the second upper wall.

15. The adaptor of claim 14, wherein the cantilevered extensions of the first and second auxiliary baking chambers are directed oppositely from each other.

16. A method for lengthening an effective baking time at a lateral end of a tunnel oven's food conveyor, said oven having a food intake and output ports respectively receiving longitudinal and oppositely longitudinal ends of said conveyor, said method comprising step of:
a. Providing a first auxiliary baking chamber having an upper wall, a lateral wall, and an oppositely lateral walls, said wall defining an interior space;
b. Attaching the first auxiliary baking chamber to the tunnel oven so that the first auxiliary baking chamber overlies the lateral end of the tunnel oven's food conveyor, and so that the first auxiliary baking chamber's interior space communicates with the tunnel oven's food intake port;
c. Placing a food item upon the continuous loop conveyor longitudinally from the first auxiliary baking chamber; and
d. Operating the food conveyor to carry the food item successively through the first auxiliary baking chamber and through the tunnel oven.

17. The method of claim 16, further comprising steps of providing a second auxiliary baking chamber having an upper wall, a lateral wall, and an oppositely lateral wall, said walls defining an interior space, attaching the second auxiliary baking chamber to the tunnel oven so that the second auxiliary baking chamber overlies the lateral end of the food conveyor, and so that the second auxiliary baking chamber's interior space communicates with the tunnel oven's food output port, and further operating the food conveyor to carry the food item through the second auxiliary baking chamber.

18. The method of claim 17, wherein the auxiliary baking chamber attaching steps comprise provisions of first and second mounting plates respectively rigidly connected to the first and second auxiliary baking chambers.

19. The method of claim 18, wherein the mounting plate provision steps provide first and second food item blocking flanges respectively extending downwardly from the first and second mounting plates.

20. The method of claim 19, wherein lower edges of the first and second food item blocking flanges respectively extend laterally or oppositely laterally from the first and second auxiliary baking chambers, said lower edges residing at elevations below the elevations of the upper walls of said auxiliary baking chambers.
